(19) United States
(12) Patent Application Publication
(10) Pub. No.: US 2026/0124940 A1
(43) Pub. Date: May 7, 2026

(54) POWER CONVERSION DEVICE

(71) Applicants: DENSO CORPORATION, Kariya-city (JP); TOYOTA JIDOSHA KABUSHIKI KAISHA, Toyota-shi (JP)

(72) Inventors: Seido ARAKI, Kariya-city (JP); Tatsuya FURUKAWA, Toyota-shi (JP); Yuji MOCHIZUKI, Toyota-shi (JP)

(73) Assignees: DENSO CORPORATION, Kariya-city (JP); TOYOTA JIDOSHA KABUSHIKI KAISHA, Toyota-shi (JP)

(21) Appl. No.: 19/439,788

(22) Filed: Jan. 5, 2026

Related U.S. Application Data
(63) Continuation of application No. PCT/JP2024/022493, filed on Jun. 21, 2024.

(30) Foreign Application Priority Data
Jul. 11, 2023 (JP) 2023-114030

(51) Int. Cl. B60L 53/24; H02M 1/44; H02M 3/335

(52) U.S. Cl. CPC B60L 53/24; H02M 1/44; H02M 3/33584; B60L 2210/12; B60L 2210/14; B60L 2270/147

(57) ABSTRACT

A power conversion device includes a negative side wiring and a positive side wiring. The positive side wiring is provided with a coil of a motor. The power conversion device uses a coil to boost a DC voltage. The power conversion device includes a Y capacitor provided between the positive side wiring and a ground, and a Y capacitor having a capacitance larger than capacitance of the Y capacitor and provided between the negative side wiring and the ground.

### CROSS REFERENCE TO RELATED APPLICATIONS

The present application is a continuation application of International Patent Application No. PCT/JP2024/022493 filed on June 21, 2024, which designated the U.S. and claims the benefit of priority from Japanese Patent Application No. 2023-114030 filed in Japan filed on July 11, 2023, the entire disclosure of the above application is incorporated herein by reference.

### TECHNICAL FIELD

The present disclosure relates to a power conversion device.

### BACKGROUND

An example of a power conversion device is a motor drive system.

### SUMMARY

The disclosed object is to provide a power conversion device capable of suppressing noise imbalance.

A power conversion device that steps up or steps down a DC voltage includes:

a negative side wiring,

a positive side wiring,

a transformer circuit including a coil provided on the positive side wiring,

a first ground capacitor provided between the positive side wiring and a ground, and

a second ground capacitor having a capacitance larger than the capacitance of the first ground capacitor and provided between the negative side wiring and the ground.

### BRIEF DESCRIPTION OF DRAWINGS

FIG. 1 is a circuit diagram showing a schematic configuration of a power conversion device;

FIG. 2 is a circuit diagram showing a schematic configuration of a motor; and

FIG. 3 is a circuit diagram showing a schematic configuration of a power conversion device according to a modified example.

### DETAILED DESCRIPTION

An example of a power conversion device is a motor drive system. The motor drive system includes an inverter including a switching element connected between a DC connection terminal and an AC connection terminal, and a motor including a plurality of coils connected to the AC connection terminal.

In order to suppress noise in the negative side and positive side wiring, the power conversion device may be configured to include capacitors between the negative side wiring and ground and between the positive side wiring and ground. However, in the power conversion device, there is a risk that a noise imbalance will occur between the negative side wiring and the positive side wiring due to a parasitic capacitance of the coil.

The disclosed object is to provide a power conversion device capable of suppressing noise imbalance.

A power conversion device that steps up or steps down a DC voltage includes:

a negative side wiring,

a positive side wiring,

a transformer circuit including a coil provided on the positive side wiring,

a first ground capacitor provided between the positive side wiring and a ground, and

a second ground capacitor having a capacitance larger than the capacitance of the first ground capacitor and provided between the negative side wiring and the ground.

The power conversion device includes the second ground capacitor, which has a capacitance larger than that of the first capacitor and is provided between the negative side wiring and the ground. Therefore, even if parasitic capacitance is formed in the coil provided in the positive side wiring, the power conversion device can suppress a deviation between the capacitor capacitance between the negative side wiring and the ground and the capacitor capacitance between the positive side wiring and the ground. Therefore, the power conversion device can suppress the imbalance of noise between the negative side wiring side and the positive side wiring side.

The disclosed aspects in this specification adopt different technical solutions from each other in order to achieve their respective objectives. The objects, features, and advantages disclosed in this specification will become apparent by referring to following detailed descriptions and accompanying drawings.

### Embodiment:

Hereinafter, various embodiments for carrying out the present disclosure will be described with reference to the drawings. In each embodiment, portions corresponding to those described in the preceding embodiment are denoted by the same reference numerals, and redundant descriptions will be omitted in some cases. In each of the embodiments, when only a part of the configuration is explained, the other part of the embodiment can be referred to the other embodiment explained previously and applied.

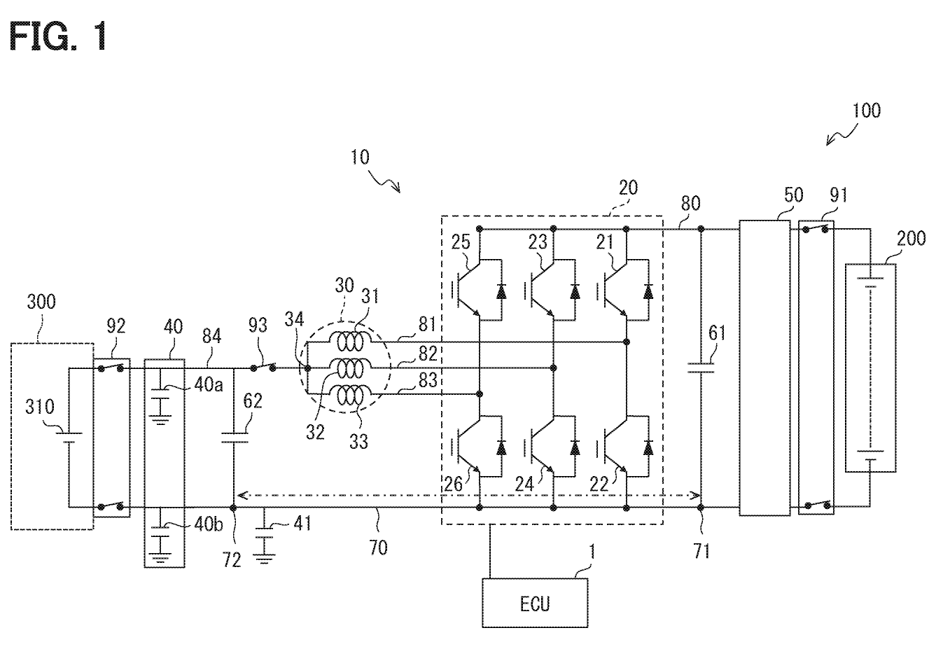

A power conversion device 100 will be described with reference to FIG. 1. FIG. 1 illustrates the power conversion device 100 in a state where a charging stand 300 is connected.

The power conversion device 100 is configured to be mountable on, for example, a mobile object. Examples of the mobile body include automobiles, trains, and aircraft. In the present embodiment, an automobile is used as an example of the mobile body. In the present embodiment, as examples of automobiles, electric vehicles or hybrid vehicles equipped with a rechargeable battery 200 are adopted. The automobile includes a power conversion device 100, a battery 200, and the like. The battery 200 corresponds to a power source or a power supply.

The power conversion device 100 includes an inverter circuit 20, a motor device 30, filters 40 and 50, capacitors 61 and 62, relays 91 to 93, a wiring group, and the like. The power conversion device 100 is connected to an ECU 1 that controls the inverter circuit 20 and the relays 91 to 93. The configuration including the power conversion device 100 and the ECU 1 can also be called a power conversion system.

The power conversion device 100 is also configured to be electrically connectable to the battery 200 and the charging stand 300 (charging power source 310). The battery 200 is mounted on the automobile together with the power conversion device 100. On the other hand, the charging stand 300 is provided outside the vehicle. Therefore, the charging stand 300 can also be considered an external device.

The power conversion device 100 operates in a drive mode in which it drives the motor device 30 and in a charge mode in which it is connected to the charging stand 300 and charges the battery 200. The state in which the charging stand 300 is connected may also be referred to as an external connection mode. Naturally, in the drive mode, the power conversion device 100 is not connected to the charging stand 300.

The battery 200 serves as the power source for the vehicle. The battery 200 may adopt, for example, a lithium-ion battery. In other words, the battery 200 is capable of being repeatedly charged and discharged. The battery 200 may also be referred to as a storage battery, rechargeable battery, or simply as a battery. The battery 200 corresponds to a power source or a power supply.

The charging stand 300 is a charging facility for recharging the battery 200. The charging stand 300 is equipped with a charging power source 310. The charging stand 300 may also be equipped with, for example, a charging cable and a computer. The charging cable is electrically connected to the charging power source 310. The charging cable is configured to be attachable to and detachable from the second relay 92. The charging power source 310 is electrically connected to power conversion device 100 by attaching a charging cable to the second relay 92.

The ECU 1 includes a processing unit such as a CPU, a memory unit including a RAM and a ROM, an input/output unit, and the like. The input/output unit is electrically connected to the switching elements 21 to 26 of the inverter circuit 20, the relays 91 to 93, and the like.

The processing unit executes programs stored in the memory device. The processing unit performs computational processing in accordance with the program. The processing unit also performs computational processing using data stored in the memory unit. The processing unit controls the switching elements 21 to 26 and the relays 91 to 93 via the input/output unit. Furthermore, the processing unit is configured to be electrically connectable to the charging stand 300 via the input/output unit. In the following, the processing operations performed by the processing unit will be described as the processing operations of the ECU 1. The processing operations of the ECU 1 will be described in detail later. The ECU 1 can also be called an electronic control unit.

The inverter circuit 20 includes, as switching elements, a U-phase upper arm switch 21, a U-phase lower arm switch 22, a V-phase upper arm switch 23, a V-phase lower arm switch 24, a W-phase upper arm switch 25, and a W-phase lower arm switch 26. The motor device 30 includes a U-phase coil 31, a V-phase coil 32, a W-phase coil 33, and a neutral point 34. Here, a three-phase motor is adopted as an example of the motor device 30. However, the present disclosure is not only limited to the above example.

The U-phase upper arm switch 21 and the U-phase lower arm switch 22 are connected in series between the negative side wiring 70 and the high voltage side wiring 80 . A connection node between the U-phase upper arm switch 21 and the U-phase lower arm switch 22 is connected to the U-phase coil 31 via the U-phase wiring 81.

The V-phase upper arm switch 23 and the V-phase lower arm switch 24 are connected in series between the negative side wiring 70 and the high voltage side wiring 80. A connection node between the V-phase upper arm switch 23 and the V-phase lower arm switch 24 is connected to the V-phase coil 32 via the V-phase wiring 82.

The W-phase upper arm switch 25 and the W-phase lower arm switch 26 are connected in series between the negative side wiring 70 and the high voltage side wiring 80. A connection node between the W-phase upper arm switch 25 and the W-phase lower arm switch 26 is connected to the W-phase coil 33 via the W-phase wiring 83.

The negative side wiring 70 and the high voltage side wiring 80 can be electrically connected to the battery 200 via a first relay 91. The negative side wiring 70 is connected to the negative terminal of the battery 200 when the first relay 91 is in the on state (closed state). The high voltage side wiring 80 is connected to the positive terminal of the battery 200 when the first relay 91 is in the on state. The negative side wiring 70 and the high voltage side wiring 80 are electrically disconnected from the battery 200 when the first relay 91 is in the OFF state (open state). Setting to the ON state may also be referred to as ON control or close control, while setting to the OFF state may also be referred to as OFF control or open control.

The neutral point of the motor device 30 is connected to a neutral point wiring 84. The neutral point wiring 84 is configured as a pair with the negative side wiring 70. The negative side wiring 70 and the neutral point wiring 84 can be electrically connected to the charging power source 310 via the second relay 92.

The negative side wiring 70 is connected to the negative electrode terminal of the charging power source 310 when the second relay 92 is in the on state. The neutral point wiring 84 is connected to the positive terminal of the charging power source 310 when the second relay 92 is in the on state. The negative side wiring 70 and the neutral point wiring 84 are electrically disconnected from the charging power source 310 when the second relay 92 is in the OFF state. The negative side wiring 70 and the neutral point wiring 84 may be provided with a fuse that blows when an overcurrent flows. The high voltage side wiring 80, the neutral point wiring 84, and the phase wirings 81 to 83 correspond to the positive side wiring.

The second relay 92 is an electrical connection port to the charging stand 300. The second relay 92 can also be called a connection terminal or an inlet. A neutral point relay 93 is provided in the neutral point wiring 84.

The inverter circuit 20 configured in this manner is controlled by the ECU 1. The ECU 1 controls each of the switching elements 21 to 26 differently in the drive mode and the charge mode.

In the drive mode, the ECU 1 controls each of the switching elements 21 to 26 to supply power from the inverter circuit 20 to the motor device 30. The inverter circuit 20 then supplies power from the battery 200 to the motor device 30. The motor device 30 is driven by the inverter circuit 20 to generate rotational driving force. The driving force generated by the motor device 30 is transmitted, for example, to the drive wheels of the automobile.

On the other hand, in the charge mode, the EUC 100 controls each of the switching elements 21 to 26 to operate the inverter circuit 20 and the motor device 30 as a boost circuit. The inverter circuit 20 and the motor device 30 operate as a boost circuit. The inverter circuit 20 and the motor device 30 boost the voltage of the charging power source 310 and supply it to the battery 200. In this way, the power conversion device 100 has the function of boosting a DC voltage.

The inverter circuit 20 and the motor device 30 correspond to a transformer circuit, a power transformer circuit or a voltage transformer circuit. Hereinafter, the inverter circuit 20 and the motor device 30 will also be referred to as the transformer circuit 10. The voltage of the charging power source 310 is also referred to as a charging voltage.

In addition, a smoothing capacitor 61 is provided between the negative side wiring 70 and the high voltage side wiring 80. The smoothing capacitor 61 can be said to be provided on one end side of the transformer circuit 10 between the negative side wiring 70 and the positive side wiring. The smoothing capacitor 61 corresponds to a first inter-wiring capacitor.

The smoothing capacitor 61 keeps the output voltage from the battery 200 constant. Furthermore, the smoothing capacitor 61 smooths the pulsed direct current supplied from the battery 200. This makes it possible to suppress surge voltage. A point where the smoothing capacitor 61 and the negative side wiring 70 are connected is referred to as a first connection point 71.

A filter capacitor 62 is provided between the negative side wiring 70 and the neutral point wiring 84. The filter capacitor 62 can be said to be provided between the negative side wiring 70 and the positive side wiring on the other end side of the transformer circuit 10. The filter capacitor 62 corresponds to a second inter-wiring capacitor.

The filter capacitor 62 keeps the voltage between the negative side wiring 70 and the neutral point wiring 84 constant. Furthermore, the filter capacitor 62 absorbs ripple currents that occur when the switching elements 21 to 26 are turned on and off. The point where the filter capacitor 62 and the negative side wiring 70 are connected is referred to as a second connection point 72.

Furthermore, an EMC filter 40 is provided between the negative side wiring 70 and the neutral point wiring 84. The EMC filter 40 includes, for example, Y capacitors 40a and 40b. The EMC filter 40 reduces noise caused by the on/off switching of the switching elements 21 to 26. In other words, the EMC filter 40 suppresses noise from flowing from the inverter circuit 20 to the second relay 92 (charging stand 300) side.

The Y capacitor 40a is provided between the neutral point wiring 84 and the ground. The Y capacitor 40a corresponds to a first capacitor to ground. The Y capacitor 40b is provided between the negative side wiring 70 and the ground.

It is preferable that the EMC filter 40 can reduce noise in the negative side wiring 70 and the neutral point wiring 84 in the same manner. In other words, the EMC filter 40 is set so that there is no imbalance in noise between the negative side wiring 70 and the neutral point wiring 84. Therefore, the Y capacitors 40a and 40b have the equivalent capacitance. Incidentally, "capacitor capacitance is equivalent" means that the capacitor capacitance is the same. Furthermore, in this disclosure, errors of a degree of variation between products are also considered to be equivalent.

The configuration of the EMC filter 40 is not limited to the above configuration. The EMC filter 40 may include a choke coil instead of the Y capacitors 40a and 40b. Furthermore, the EMC filter 40 may be provided with choke coils in the negative side wiring 70 and the neutral point wiring 84, in addition to the Y capacitors 40a and 40b. Similarly, an EMC filter 50 is provided between the negative side wiring 70 and the high voltage side wiring 80. In addition, the power conversion device 100 has equivalent capacitances formed between the negative side wiring 70 and the ground and between the neutral point wiring 84 and the ground.

The high voltage side wiring 80 is arranged closer to the first relay 91 than the transformer circuit 10. The neutral point wiring 84 is arranged closer to the second relay 92 than the transformer circuit 10. Here, the first relay 91 side of the transformer circuit 10 corresponds to one end side, and the second relay 92 side of the transformer circuit 10 corresponds to the other end side.

Furthermore, when the inverter circuit 20 and the motor device 30 function as a boost circuit, the voltage between the negative side wiring 70 and the neutral point wiring 84 becomes lower than the voltage between the negative side wiring 70 and the high voltage side wiring 80. Therefore, in the present embodiment, one end side can be said to be the high voltage side and the other end side can be said to be the low voltage side. Furthermore, the high voltage side wiring 80 can also be said to be a positive side wiring on the high voltage side. The neutral point wiring 84 can also be said to be the positive side wiring on the low voltage side.

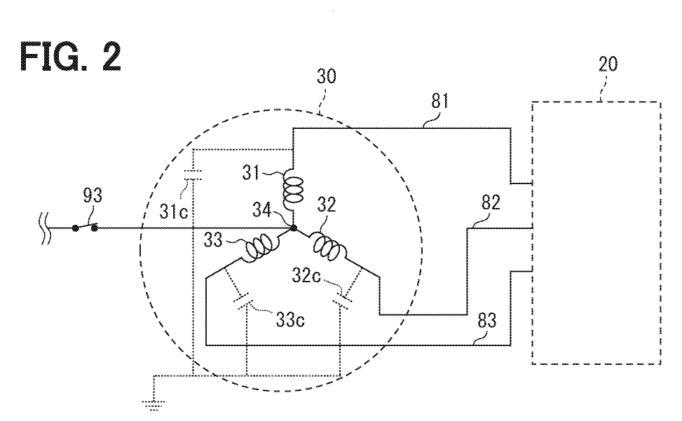

As shown in FIG. 2, the motor device 30 includes parasitic capacitances (stray capacitances) 31c to 33c. More specifically, the U-phase coil 31 includes a parasitic capacitance 31c. The V-phase coil 32 includes a parasitic capacitance 32c. The W-phase coil 33 includes a parasitic capacitance 33c. Each of the parasitic capacitances 31c to 33c is formed between each of the phase wirings 81 to 83 and the ground. Therefore, each of the phase wirings 81 to 83 can be regarded as having a Y capacitor. Furthermore, each of the parasitic capacitances 31c to 33c can be considered as a Y capacitor of the motor device 30.

Therefore, the capacitance of the Y capacitor differs between the positive side wiring side and the negative side wiring 70 side. That is, in the EMC filter 40, the capacitances of the Y capacitors 40a and 40b are set to be equal to each other. However, parasitic capacitances 31c to 33c are formed on the positive side wiring side. Therefore, the capacitance of the Y capacitor of the positive side wiring is larger than that of the negative side wiring 70. The capacitance of the capacitor between the positive wiring side and the ground is different from the capacitance of the capacitor between the negative side wiring 70 and the ground.

Therefore, the power conversion device 100 includes a Y capacitor 41 connected to the negative side wiring 70. The Y capacitor 41 is provided between the negative side wiring 70 and the ground. The Y capacitor 41 suppresses noise from flowing from the inverter circuit 20 to the second relay 92 (charging stand 300) side. The power conversion device 100 has a capacitor having a larger capacitance than the capacitance of the Y capacitor 40a formed between the negative side wiring 70 and the ground.

The Y capacitor 41 is preferably provided between the smoothing capacitor 61 and the filter capacitor 62. That is, the Y capacitor 41 is connected between the first connection point 71 and the second connection point of the negative side wiring 70. The Y capacitor 41 may also be composed of a plurality of capacitor elements.

The capacitance of the Y capacitor 41 is greater than the capacitance of the Y capacitor 40a. That is, the Y capacitors 40b and 41 have a capacitance larger than that of the Y capacitor 40a. The Y capacitor 41 is provided to suppress the difference in capacitance between the Y capacitors on the positive side wiring side and the negative side wiring 70 side. The power conversion device 100 has a configuration in which the capacitance between the negative side wiring 70 and the ground is larger than that between the neutral point wiring 84 or the high voltage side wiring 80 and the ground. The Y capacitors 40b and 41 correspond to second ground capacitors.

It is preferable that the difference between the capacitance of the Y capacitor 40a and the capacitance of the Y capacitors 40b and 41 is equal to the parasitic capacitances 31c to 33c. In other words, it is preferable that the difference between the capacitance of the Y capacitor 40a and the capacitance of the Y capacitors 40b and 41 be equal to the capacitance of the Y capacitor of the motor device 30. The Y capacitor of the motor device 30 can also be called a virtual capacitor.

Furthermore, the Y capacitor 40a and the Y capacitor 40b have the same capacitance. Therefore, it is preferable that the difference between the capacitance of the Y capacitor 40a and the capacitance of the Y capacitor 41 is equal to the parasitic capacitances 31c to 33c.

Furthermore, on the positive side wiring side, the Y capacitor 40a and each Y capacitor of the motor device 30 are connected in parallel. On the other hand, on the negative side wiring 70 side, the Y capacitors 40b and 41 are connected in parallel. Therefore, the combined capacitance of the Y capacitors on the positive side wiring is equal to the combined capacitance of the Y capacitors on the negative side wiring 70 side.

The Y capacitor 40b may not be provided. In this case, it is preferable that the difference between the capacitance of the Y capacitor 40a and the capacitance of the Y capacitor 41 be equal to the capacitance of the Y capacitor of the motor device 30.

### Effect:

In this way, the power conversion device 100 includes the Y capacitor 41, which has a capacitance larger than that of the Y capacitor 40a and is provided between the negative side wiring 70 and the ground. Therefore, even if parasitic capacitances 31c to 33c are formed in the coils 31 to 33 provided in the positive side wiring, the power conversion device 100 can suppress the deviation between the capacitor capacitance between the negative side wiring 70 and ground and the capacitor capacitance between the positive side wiring and ground. Therefore, the power conversion device 100 can suppress the imbalance of noise between the negative side wiring 70 side and the positive side wiring side.

The power conversion device 100 also includes EMC filters 40 and 50. The power conversion device 100 can suppress the noise imbalance, thereby improving the noise reduction effect of the EMC filters 40 and 50.

As described above, the EMC filter 40 may also be configured to include a choke coil. In this case, it is preferable to set the capacitance of the Y capacitor 41 so that the deviation of the combined capacitance between the positive side wiring side and the negative side wiring 70 side is suppressed, taking into consideration the parasitic capacitance of the choke coil.

The power conversion device 100 may also be configured without the EMC filter 40. In this case, by providing the power conversion device 100 with the Y capacitor 41, the deviation of the combined capacitance between the positive side wiring side and the negative side wiring 70 is suppressed. In this case, it is preferable that the capacitance of the Y capacitor 41 is equal to the parasitic capacitances 31c to 33c.

In other words, in a configuration in which coils 31 to 33 are provided on the positive side wiring of the power conversion device 100, the Y capacitor 41 or the like may be provided to suppress the discrepancy between the capacitor capacitance between the positive side wiring and ground and the capacitor capacitance between the negative side wiring 70 and ground.

In the present embodiment, an example is adopted in which the inverter circuit 20 and the motor device 30 are used as a boost circuit (transformer circuit 10). However, the present disclosure is not only limited to the above example. The power conversion device 100 may include a voltage transformer circuit 10 having a switching element that is not part of the inverter circuit 20 and a coil that is not part of the motor device 30. That is, the power conversion device 100 can be configured to include a transformer circuit 10 having only one coil and only one switching element.

Moreover, instead of the charging stand 300, the power conversion device 100 may be electrically connected to a house or the like as an external device. In this case, the second relay 92 is connected to the electrical outlet of the house. The power conversion device 100 is electrically connected to a storage battery, a distribution board, and the like provided in the house.

The power conversion device 100 supplies (feeds) the power of the battery 200 to a storage battery or the like in the house while being electrically connected to the house. That is, the power conversion device 100 operates in the power supply mode.

The inverter circuit 20 and the motor device 30 function as a step-down circuit (transformer circuit 10) in the power supply mode. The inverter circuit 20 and the motor device 30 step down the voltage of the battery 200 and supply the voltage to a device such as the storage battery.

In this case, the EUC 1 controls the switching elements 21 to 26 to operate the inverter circuit 20 and the motor device 30 as a step-down circuit. As a result, the stepped-down voltage of the battery 200 is supplied to a device such as the storage battery.

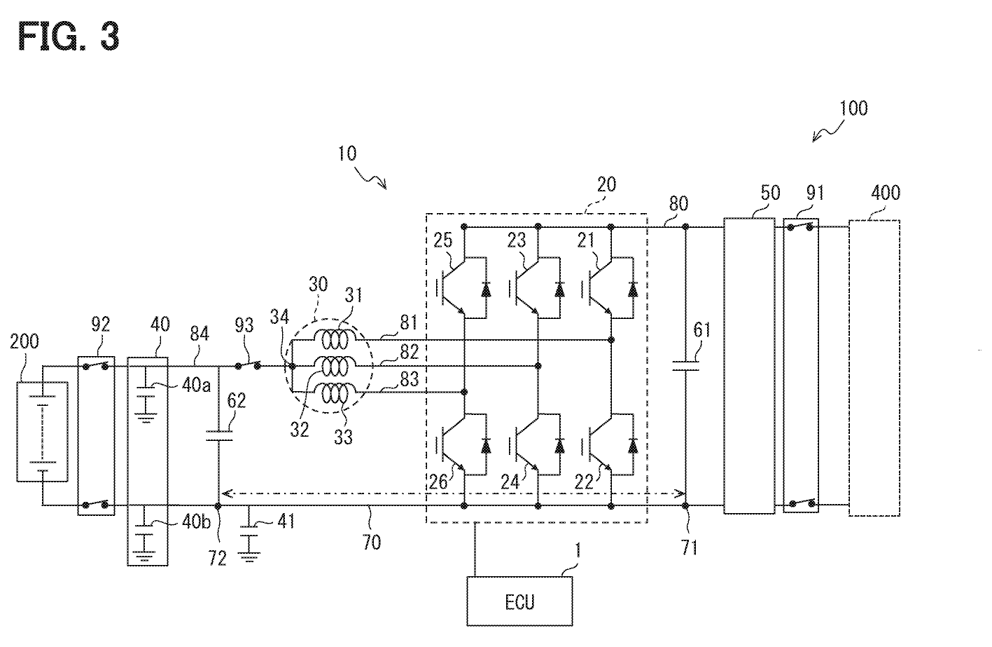

Furthermore, as in a modified example shown in FIG. 3, a configuration may be adopted in which a battery 200 can be connected to the second relay 92. In this case, the first relay 91 is connected to a sub-battery 400 that is different from the battery 200 and is installed in the automobile. The power conversion device 100 then steps down the power of the battery 200 and supplies it to the sub-battery 400 connected to the first relay 91. The first relay 91 may also be configured to be switchably connected to a plurality of sub-batteries with different voltages. In this configuration, reference numeral 80 denotes a positive side wiring on the low voltage side, and reference numeral 84 denotes a positive side wiring on the high voltage side.

The preferred embodiments of the present disclosure have been described above. However, although the present disclosure has been described in accordance with the embodiments, it is understood that the present disclosure is not limited to these embodiments or structures. The present disclosure also encompasses various modifications and equivalents within its scope. In addition, while various combinations and modes are described in the present disclosure, other combinations and modes including only one element, more elements, or less elements therein are also within the scope and spirit of the present disclosure.

What is claimed is:

1. A power conversion device for stepping up or stepping down a DC voltage, comprising:
a negative side wiring;
a positive side wiring;
a transformer circuit including a coil provided on the positive side wiring;
a first ground capacitor provided between the positive side wiring and a ground; and
a second ground capacitor having a capacitance larger than a capacitance of the first ground capacitor and provided between the negative side wiring and the ground.

2. The power conversion device according to claim 1, further comprising,
a first inter-wiring capacitor provided between the negative side wiring and the positive side wiring at one end side of the transformer circuit, and
a second inter-wiring capacitor provided between the negative side wiring and the positive side wiring at the other end of the transformer circuit, wherein
the second ground capacitor is provided between the first inter-wiring capacitor and the second inter-wiring capacitor.

3. The power conversion device according to claim 1, wherein
a difference between a capacitance of the first ground capacitor and the capacitance of the second ground capacitor is equal to a parasitic capacitance of the coil.

4. The power conversion device according to claim 1, further comprising,
a motor including the coil, and
an inverter circuit including a plurality of switching elements and supplying power to the motor.

5. The power conversion device according to claim 4, further comprising,
a filter provided between the negative side wiring and the positive side wiring to suppress noise due to switching operations of the plurality of switching elements.
